(19) United States
(12) Patent Application Publication
(10) Pub. No.: US 2006/0136337 A1
(43) Pub. Date: Jun. 22, 2006

(54) Method of providing secure fulfillment of online purchased services

(75) Inventors: Reza M. Sheikhrezai, Atherton, CA (US); Rahul Khona, San Jose, CA (US); Sanjay Nighojkar, Santa Clara, CA (US)

Correspondence Address: Ali Kamarei, Esq., 280 Colorado Avenue, Palo Alto, CA, 94301, US

(73) Assignee: Sheikhrezai, Khona, Nighojkar

(21) Appl. No.: 11/019,771

(22) Filed: Dec. 20, 2004

(51) Int. Cl. G06Q 40/00

(52) U.S. Cl. 705/44

(57) ABSTRACT

The invention provide a method for verification of receipt of services delivered in person to a buyer in an online service sales transaction prior to release of funds by a service sales system to the seller of a service. An electronic buyer's voucher generated by the service sales system is issued to the buyer upon obtaining funds from the buyer in a financial transaction. The funds are not released to the seller until the service is dispensed to the buyer. The buyer's electronic voucher contains both a transaction identification code which identifies the commercial transaction between the seller and the buyer, and a funds release authorization code. An electronic seller's voucher is also issued by the service sales system to the seller, the seller's electronic voucher containing the transaction identification code. In order to receive services the buyer must provide the seller with the transaction identification code. The buyer also provides the seller with a funds release authorization code, in order for the service sales system to release funds to the seller. The method further provides for a rating code, which is used to rate the quality of service received by the buyer without disclosing that rating to the seller.

### FIELD

This invention relates to a method to provide dispensing of services by service providers via a buyer's voucher that allows sellers to verify that a buyer has purchased a service, and allows buyers to make sure services are provided before funds are released to the service provider. The invention also provides proof of delivery of service for protection of the seller. Furthermore, the invention relates to a method of providing a quality feedback mechanism so that the services providers service quality is independently and automatically rated by the buyer.

### BACKGROUND

The Internet has been a great boon and equalizer for selling merchandize. Companies of all sizes from small individual sellers to large multinational corporations have been selling merchandise on the Internet. The sales typically occur in public market places like eBay, Yahoo, Amazon, Overstock, etc. or on the sellers' individual websites.

While merchandize vendors have successfully leveraged the Internet to increase their sales and profits, either through direct sales or through an auction platform, businesses selling services have not been very successful except in certain sectors such as travel and finance.

The primary reason why sales of merchandise has been successful is the ability of the vendor to ship merchandise to the destination specified by the buyer using third party delivery services. Third party delivery services provide a mechanism to unambiguously ascertain whether the seller actually shipped the services and whether the merchandize was delivered at the location specified by the seller. This allows credit card companies or payment collection companies like PayPal to guarantee the buyer that the buyer does not have to pay if there is a fraud. It also gives seller the guarantee that if the buyer falsely claims non-receipt of goods, they can produce proof of shipment to the credit card company and get their payment.

Services on the other hand are not shippable. They have to be consumed at either the sellers' location or at a location specified by the buyer. Traditionally, Internet based sales involve prepayment for the purchase before the service or product is delivered. Since in local delivery there is no shipping company involved that can ascertain whether the service was actually delivered by the seller of services and consumed by the buyer, it becomes risky for both the buyer and seller of services to conduct business online. Both the buyer and seller of services online can be defrauded or fall victim to errors by other persons. The invention described herein enables secure sales of services online and trusted delivery of services to the consumer in spite of unavailability of third party shipping companies to deliver them. The invention provides a guarantee to buyers that the money paid by them online for a service purchase will not be paid to the seller unless the buyers receive the service that was promised. In addition, the seller is guaranteed that the buyers would not be able to make false claims about non-consumption of the service to block the payment. The invention will also provide a guarantee to the buyers that nobody but the buyers or their nominee would be able to claim the service and it will provide the guarantee to the seller that only the buyers or their nominee claims the service that was prepaid for on the Internet.

In many situations buyers and sellers have tried to arrange a pick-up or consumption at sellers' location after prepayment on the Internet using buyers' credit card as authentication mechanism. The buyers present their credit card and a photo identification for verification. This mechanism has several flaws. First, it does not work in situations where buyer designates other people to consume the service. Often buyers can ask their spouse or children to get the service done once they have paid for it over the Internet. It does not work for gift situations. Entertainment services are often given as gifts to friends. Credit card of payer cannot be used for authentication at that point. There is an increasing trend of using one-time use credit cards while purchasing over the Internet. These credit cards are not physical and the buyer is provided a credit card number over the Internet by the Bank that he/she uses to make payments while purchasing online. In this situation authentication cannot take place. Other forms of internet payments are becoming popular such as electronic funds transfer (EFT) or eChecks, which again result in a situation where seller cannot authenticate the consumer and thus not provide the service. It does not provide a guarantee to the buyer that the seller will not receive money until the service is provided. It does not give an unambiguous proof to the seller that buyer actually consumed the service since payment is made online and the buyer does not have to sign a credit card voucher indicating delivery of service.

The invention overcomes all these problems by providing a completely secure verification/authentication mechanism for sellers and completely secure escrow mechanism for buyer to allow purchase of services online that require in person delivery, without having to resort to independent and expensive third party escrow entities.

This invention also replaces on line coupons into actionable ones by which the services can be sold on line and fulfilled securely via the described method. Services that are sold on line as outlined by the present invention connects the service provider to the buyer or recipient of the service in a manner which encourages trusted online purchase of services.

### SUMMARY

The invention provides a method for verification of receipt of services delivered in person to a buyer in an online service sales transaction prior to release of funds by a service sales system to the seller of a service, comprising of the following steps: issuance of an electronic buyer's voucher by the service sales system to the buyer upon the service sales system obtaining funds from the buyer in a financial transaction, said funds not released to the seller until the service is dispensed by the seller to the buyer, the buyer's electronic voucher containing both a transaction identification code which identifies the commercial transaction between the seller and the buyer, and a funds release authorization code, issuance of an electronic seller's voucher by the service sales system to the seller, the seller's electronic voucher containing the transaction identification code, tender of the transaction identification code by the buyer or buyer's designee to the seller to obtain services, verifying that the buyer is entitled to receive services from the seller, the seller dispensing the purchased service to the buyer or buyer's designee, and the buyer or buyer's designee providing a funds release authorization code, in order for the service sales system to release funds to the seller.

In an alternative embodiment the funds release authorization code comprises of a rating code. Optionally the rating code is randomly generated by the service sales system. Further as an option, the rating code is provided by the buyer to the seller. Where a rating code is given by the buyer to the seller, the code signifies the level of satisfaction of the buyer with the seller's services. This is optionally satisfaction with the timeliness of the service, the skill of the service provider, and/or courtesy of the service provider.

In an alternative embodiment, the seller must provide a rating code to the service sales system in order to receive funds from the service sales system for the services it provided to the buyer. It is an option that the level of satisfaction of the buyer with the seller contained in the rating code given by the buyer to the seller is not known to the seller from the rating code. The rating code enables the service sales system to receive instant feedback from buyers about the quality of services dispensed by a particular service provider. Optionally, the rating code is unique to a particular buyer's voucher.

Therefore, the invention has the following objectives. First, there is an objective to provide a method of trusted payment and delivery of a service using an online sales system. Payment is made by the buyer but not transferred to the seller until the buyer confirms that payment has been made.

Second, it is an objective to provide for a rating code which is given by the buyer as part of a funds release authorization code to the service sales system. This provides for an automatic rating of the quality of the service by the seller while at the same time authorizing the release of funds.

### BRIEF DESCRIPTION OF DRAWINGS

FIG. 1 shows the over all structure of an embodiment of the invention showing the relation between the buyer, the seller (also service provider), and the service sales system.

FIG. 2 shows a flow chart of the various steps taken in consummating a financial transaction between the seller and the buyer, and the eventual release of funds to the seller after receipt of the funds release authorization code from the seller.

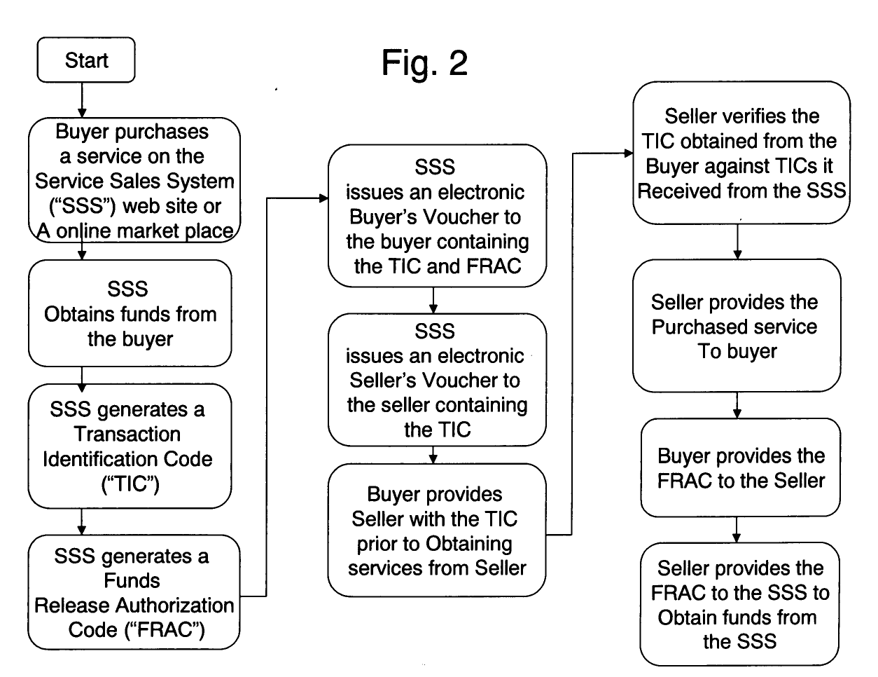

FIGS. 3a and 3b show an embodiment of the buyer's voucher and the seller's voucher.

FIG. 4 shows an embodiment of the funds release authorization code having a secret random rating code.

FIGS. 5a and 5b show an alternative embodiment of the buyer's voucher and the seller's voucher.

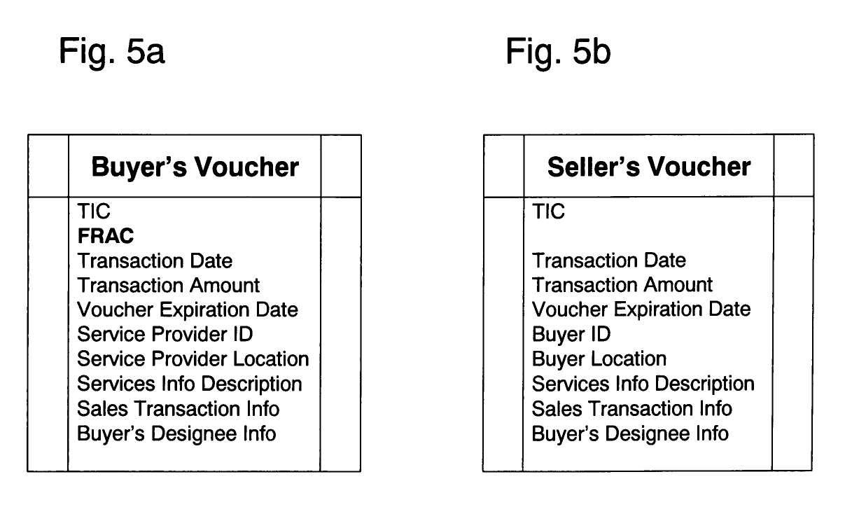

### DETAILED DESCRIPTION

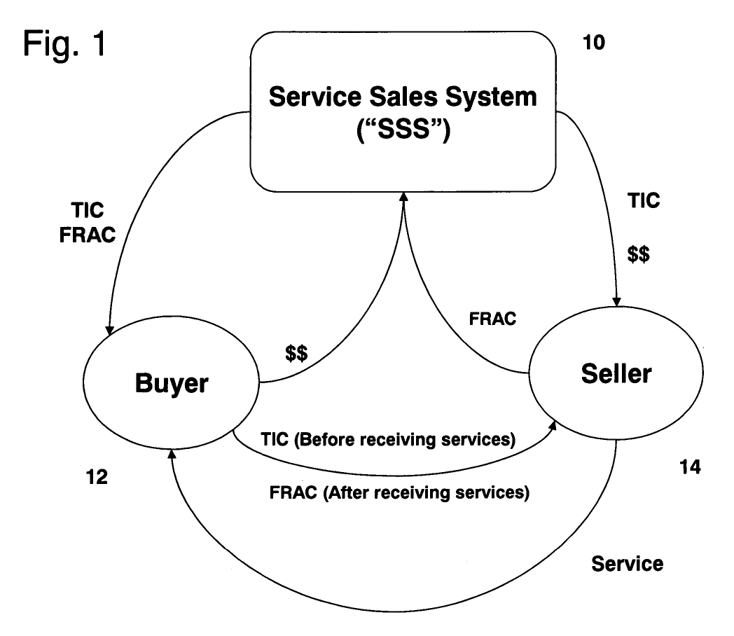

The invention provides a device and method for the online purchase of various services which services are provided locally. As is shown in FIG. 1, the service sales system 10 (hereinafter “SSS”) is at the core of the operation and is responsible for the sales process. A buyer 12 of services visits the service sales system web site or public online market place. After searching for or browsing through the various services provided on the service sales system, the buyer makes a selection and pays for the service to be provided by the service provider. It is understood that the SSS is either a traditional buy-sell web site such as a retail web site, or a public online market place such as eBay and the like. Regardless, whether the buyer is a purchaser in a web site or is the winning bid in an auction web site, the buyer provides funds to the SSS in order to conduct a financial transaction. In the financial transaction, the buyer provides funds in order to receive services from the seller 14. Therefore, as is evident, in the financial transaction, the idenitity of the buyer, the seller, the services purchased and the amount paid for the services must be determined.

Financial Transaction

A financial transaction is described as the exchange of funds between the SSS and the buyer for services. The financial transaction (or “transaction”) is uniquely identified by the SSS by giving it a unique Transaction Identification Code (“TIC”). That is, through the transaction identification code, the SSS is able to identify the buyer, the seller, the date of the transaction, the amount of the transaction, and the services purchased. In an alternative embodimet and as an option, it is understood that more than one voucher can issue pursuant to a single financial transaction. In addition, it is possible that other information will also be identifiable from the transaction identification code, such as (description of ot type of service to be provided, number of units of service (3 haircuts), time window in which to provide the service (oil service between 10:00 am and 11:00 am only), and other information. Until the time services are dispensed by the buyer to the seller and received by the buyer from the seller, the funds received by the SSS are not released to the seller as more fully described below.

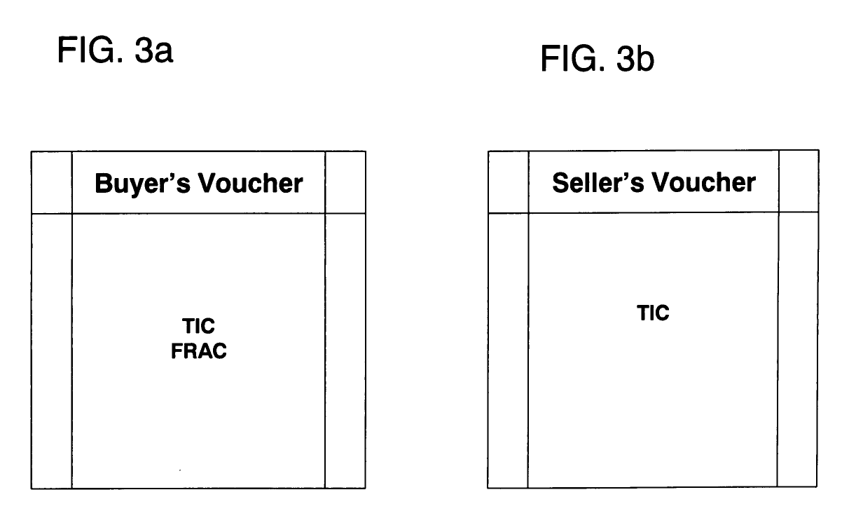

Upon completion of the financial transaction, the SSS provides the buyer with an electronic Buyer's Voucher. The electronic Buyer's Voucher, which can delivered to the buyer in a variety of ways, such as by email, fax, or downloaded by the user from a specified URL address, contains the transaction identification code and a Funds Release Authorization Code (“FRAC”) which is also generated by the SSS. As is shown in FIG. 3a, optionally, the buyer's voucher also contains the transaction date, transaction amount, seller's identity, the transaction amount, and the like. Also upon completion of the financial transaction, the SSS provides the seller with an electronic Seller's Voucher. The Seller's Voucher, which can be delivered to the seller via facsimile or email, also contains the transaction identification code. As is shown in FIG. 3b, optionally, the seller's voucher also contains the transaction date, transaction amount, transaction amount, the buyer's identity, and the like. The FRAC is not provided to the seller by the SSS.

Funds Release Authorization

For redeeming the Buyer's Voucher and obtaining services that the buyer has paid for, the buyer or the buyer's designee, tenders the transaction identification code in the buyer's voucher to the seller. A buyer's designee is someone who did not purchase the service, but is authorized to receive the service, as in a voucher that includes the buyers designee's identity for example as a gift voucher. In this embodiment the identity of the buyer's deisgnee is provided by the buyer to the service sales system, which is then optionally included in the buyer's voucher. The receipt is optionally someone that the buyer gives a voucher to. Because what is being dispensed by the seller is services rather than a product, the services are delivered local to the buyer, whether at the place of business of the seller, or where the buyer selects. Upon receipt of the transaction identification code, the seller verifies the financial transaction by comparing it with any transaction identification codes in Seller Vouchers it has received from the SSS. If there is a match between the buyer's tendered TIC and seller's TIC, the seller verifies that indeed the buyer or the buyer's designeee, has paid for the services and is entitled to receive services from the seller. In an alternative optional embodiment, the buyer directly forwards the TIC to the service sales system, such as using a computing device to enter the TIC into a URL operated by the service sales system. A notification is then sent to the service provider that the buyer or buyer's designee is entitled to receive the service.

The Seller's Voucher optionally indicates what services the buyer is entitled to receive. Any sales information including the description fo services the buyer is entitled to receive or the transaction amount are optionally contained in a form other than in the seller's voucher. The seller then proceeds to perform services for the buyer. Upon competion of the services fro the buyer, the buyer provides a funds release authorization code (“FRAC”) to the seller. The seller in turn provides the TIC and the FRAC to the SSS. The receipt of the TIC and the FRAC by the SSS allows the SSS to identify the the transaction, thus identifying the buyer, the seller, and the amount of the transaction, using the TIC, and receipt of the FRAC signals the SSS that the services have been provided. Accordingly, the SSS issues a payment of funds to the seller.

In an alternative optional embodiment, the buyer directly forwards the FRAC to the service sales system, such as using a computing device to enter the FRAC into a URL operated by the service sales system. Regardless, a notification is then sent to the service provider that the buyer has approved authorization of the release of funds. The funds may be issued electroically, such as electronically crediting a seller's previously designated financial account such as a checking account, or the issuance of a paper check in the name of the seller. If the seller does not provide a FRAC to the SSS, no funds will be released to it.

In the event that the seller performs the agreed upon services but the buyer does not provide it with a FRAC, the seller can submit an Dispute Resolution Code (“DRC”) to the SSS. The DRC allows the SSS to hold the funds and not return it to the buyer until any dispute between the buyer and the seller is resolved.

Rating Code

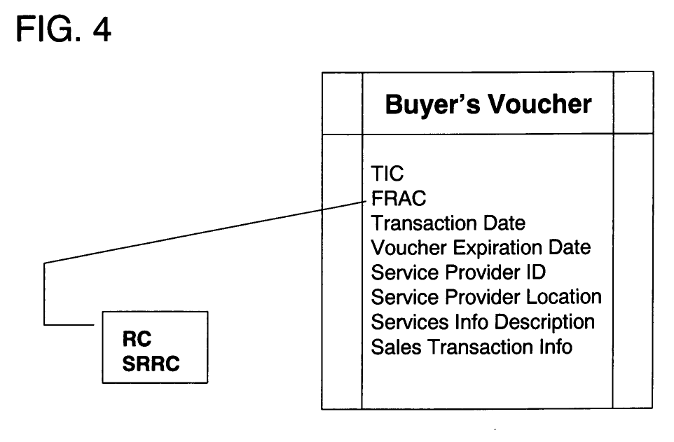

As is shown in FIG. 4, optionally, the FRAC generated by the SSS is comprised of two components. The first component acts as a funds release authorization code, which simply signals to the SSS that funds should be released to the seller. The second component of the FRAC is a rating code (“RRSC”), which is optionally a random rating scale generated by the SSS for financial transactions. Optionally, a unique random RRSC is generated by the SSS for each financial transaction. In an embodiment where multiple vouchers are generated by the SSS for a single financial transaction, a different RRSC is generated for each voucher. The RRSC functions to provide a “quality” rating scale for the buyer to rate the seller's service quality. The quality rating scale is intended to allow the buyer to rate the seller's timeliness, courtesy, skill, and any other satisfaction factor or criteria recognized by the buyer, in the sellers dispense of services to the buyer. Such quality rating is optionally used by the SSS to rank the seller on a web site, for example, whether a seller should appear above or lower than other service providers on a web site. Optionally, the quality rating of the seller is posted next to the identity of the seller to provide better guidance for buyers in selecting, or purchasing services form a seller.

Regardless, the RRSC functions to provide a feedback mechanism by the buyer for the benefit of future buyers of that same seller, or others such as the superiors of the service provider. As an example, the services of a truck driver is rated by the buyer recipient so that the owners of the truck or supervisors of the truck driver can evaluate the performance and/o service of their own truck driver. As another example, a company that operates on a franchise basis is able to monitor feedback from customers regarding the quality of service of individual franchisees. In an embodiment, the random rating scale is not revealed to the seller, such that when the buyer provides a random rating code to the seller, the seller is unaware whether the rating code is a “good” rating or a “bad” rating. In another embodiment, the rating scale is unique to a specific financial transaction, therefore, the rating code provided by the SSS to the buyer and the buyer to the seller, is unique to a particular financial transaction. In an optional embodiment, the rating code is a “poor” rating, which prevents authorization of the release of funds to the seller.

Thus, in an optional embodiment shown in FIG. 4, the FRAC is alternatively comprised of a release code (“RC”), which authorizes release of the funds and a secret random rating code to signifies the level of satisfaction of the buyer with the seller's services.

From the aforementioned description, it is appreciated how the objectives and features of the above-described invention are met. First, the invention provides for a method of trusted payment and delivery of a service using an online sales system. Payment is made by the buyer but not transferred to the seller until the buyer confirms that payment has been made.

Second, the method provides for a rating code which is given by the buyer as part of a funds release authorization code. This provides for an automatic rating of the quality of the service by the seller while at the same time authorizing the release of funds.

This invention has been described with respect to a particular Internet based service sales system. However, it is appreciated that various modifications of the apparatus and method are possible without departing from the invention, which is defined by the claims set forth below.

What is claimed is:

1. A method for verification of receipt of services delivered in person to a buyer in an online service sales transaction prior to release of funds by a service sales system to the seller of a service, comprising of the following steps:
a. issuance of an electronic buyer's voucher by the service sales system to the buyer upon the service sales system obtaining funds from the buyer in a financial transaction, said funds not released to the seller until the service is dispensed by the seller to the buyer, the buyer's electronic voucher containing both a transaction identification code which identifies the commercial transaction between the seller and the buyer, and a funds release authorization code,
b. issuance of an electronic seller's voucher by the service sales system to the seller, the seller's electronic voucher containing the transaction identification code,
c. tender of the transaction identification code by the buyer or buyer's designee to the seller to obtain services,
d. verifying that the buyer is entitled to receive services from the seller,
e. the seller dispensing the purchased service to the buyer or buyer's designee, and
f. the buyer or buyer's designee providing a funds release authorization code, in order for the service sales system to release funds to the seller.

2. The method of claim 1 wherein the funds release authorization code comprises of a rating code.

3. The method of claim 2 wherein the rating code is randomly generated by the service sales system.

4. The method of claim 2 wherein the rating code is provided by the buyer to the seller.

5. The method of claim 4 wherein the rating code given by the buyer to the seller signifies the level of satisfaction of the buyer with the seller's services.

6. The method of claim 4 wherein the rating code provided by the buyer to the seller is an indication of the timeliness of the service, the skill of the service provider, and/or courtesy of the service provider.

7. The method of claim 2 wherein the seller must provide a rating code to the service sales system in order to receive funds from the service sales system.

8. The method of claim 2 wherein the level of satisfaction of the buyer with the seller contained in the rating code given by the buyer to the seller is not known to the seller from the rating code.

9. The method of claim 2 wherein the rating code enables the service sales system to receive instant feedback from buyers about the quality of services dispensed by a particular service provider.

10. The method of claim 2 wherein the rating code is unique to a particular buyer's voucher.

11. The method of claim 1 wherein the buyer's voucher comprises of one or more of the following information; financial transaction date, financial transaction amount, buyer's voucher expiration date, buyer identification information, service provider identification information, service provider contact information, service provider location information, purchased services information, and sales transaction information.

12. The method of claim 1 wherein the seller's voucher comprises of one or more of the following information; financial transaction date, financial transaction amount, buyer's voucher expiration date, buyer identification information, service provider contact information, service provider location information, purchased services information, and sales transaction information.

13. The method of claim 1 wherein the transaction authorization code uniquely identifies the transaction between a buyer and seller.

14. A method for verification of receipt of services delivered in person to a buyer in an online service sales transaction prior to release of funds by a service sales system to the seller of a service, comprising of the following steps:
a. issuance of an electronic buyer's voucher by the service sales system to the buyer upon the service sales system obtaining funds from the buyer in a financial transaction, said funds not released to the seller until the service is dispensed by the seller to the buyer, the buyer's electronic voucher containing both a transaction identification code which identifies the commercial transaction between the seller and the buyer, and a funds release authorization code,
b. issuance of an electronic seller's voucher by the service sales system to the seller, the seller's electronic voucher containing the transaction identification code,
c. tender of the transaction identification code by the buyer or buyer's designee to the seller to obtain services,
d. verifying that the buyer is entitled to receive services from the seller,
e. the seller dispensing the purchased service to the buyer or buyer's designee, and
f. the buyer or buyer's designee providing a funds release authorization code, in order for the service sales system to release funds to the seller, wherein the funds release authorization code comprises of a rating code.

15. The method of claim 14 wherein the rating code is randomly generated by the service sales system.

16. The method of claim 14 wherein the rating code is provided by the buyer to the seller.

17. The method of claim 16 wherein the rating code given by the buyer to the seller signifies the level of satisfaction of the buyer with the seller's services.

18. The method of claim 16 wherein the rating code provided by the buyer to the seller is an indication of the timeliness of the service, the skill of the service provider, and/or courtesy of the service provider.

19. The method of claim 14 wherein the seller must provide a rating code to the service sales system in order to receive funds from the service sales system.

20. The method of claim 14 wherein the level of satisfaction of the buyer with the seller contained in the rating code given by the buyer to the seller is not known to the seller from the rating code.
